(19) United States
(12) Patent Application Publication
(10) Pub. No.: US 2014/0376759 A1
(43) Pub. Date: Dec. 25, 2014

(54) LOUDSPEAKER HAVING CARBON NANOTUBES

(71) Applicant: HON HAI PRECISION INDUSTRY CO., LTD., New Taipei (TW)

(72) Inventor: JEN-TSORNG CHANG, New Taipei (TW)

(73) Assignee: HON HAI PRECISION INDUSTRY CO., LTD., New Taipei (TW)

(21) Appl. No.: 14/038,768

(22) Filed: Sep. 27, 2013

(30) Foreign Application Priority Data
Jun. 21, 2013 (TW) 102122069

(51) Int. Cl. H04R 1/28

(52) U.S. Cl. CPC H04R 1/2803
USPC 381/345

(57) ABSTRACT

A loudspeaker includes a cover and a base. The cover together with the base defines a high frequency space, a middle frequency space, and a low frequency space. Micro holes are defined in the high frequency space, the middle frequency space, and the low frequency space. Height of the middle frequency space is larger than that of the high frequency space and smaller than that of the low frequency space. A drive, a pole, and a carbon nanotube film are located in the high, middle, and low frequency spaces. The drive connects with the carbon nanotube film to make the carbon nanotube film produce sound waves. The sound waves transmit through the micro holes.

### BACKGROUND

1. Technical Field

The present disclosure relates to loudspeakers and, particularly, to a loudspeaker comprising carbon nanotubes.

2. Description of Related Art

Loudspeakers are acoustic devices transforming received electric signals into sounds. There are different types of loudspeakers that can be categorized according to their working principles, such as electro-dynamic loudspeakers, electromagnetic loudspeakers, electrostatic loudspeakers, and piezoelectric loudspeakers. The electro-dynamic loudspeakers have simple structures, good sound qualities, low costs, and are most widely used.

The electro-dynamic loudspeaker typically includes a voice coil, magnet, and a polymer diaphragm. The voice coil is an electrical conductor and is placed in the magnetic field of the magnet. By applying an electrical current to the voice coil, a mechanical vibration of the polymer diaphragm is produced by the voice coil and the magnetic field of the magnet. The polymer diaphragm reproduces the sound pressure waves corresponding to the electric signals.

The thickness of the polymer diaphragm has an un-uniform distribution, thus the sound quality, particularly to the bass portion, is reduced.

Therefore, it is desirable to provide a loudspeaker having carbon nanotubes, which can overcome the limitation described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic sectional view of a loudspeaker, according to an exemplary embodiment of the present disclosure, the loudspeaker including poles and carbon nanotubes.

FIG. 2 is a schematic view of the poles and the carbon nanotubes of the loudspeaker shown in FIG. 1.

### DETAILED DESCRIPTION

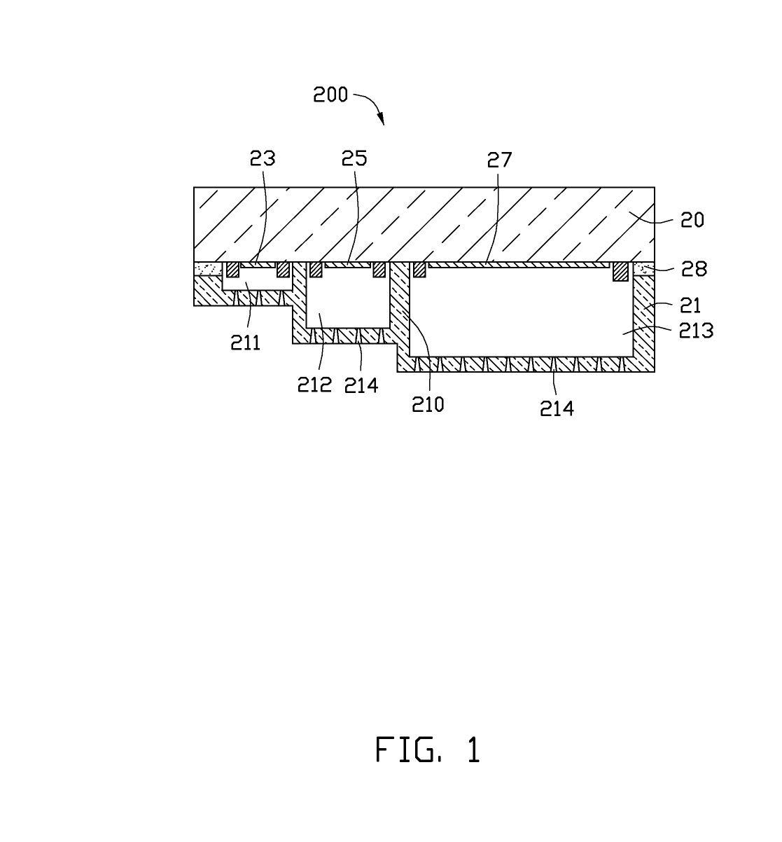

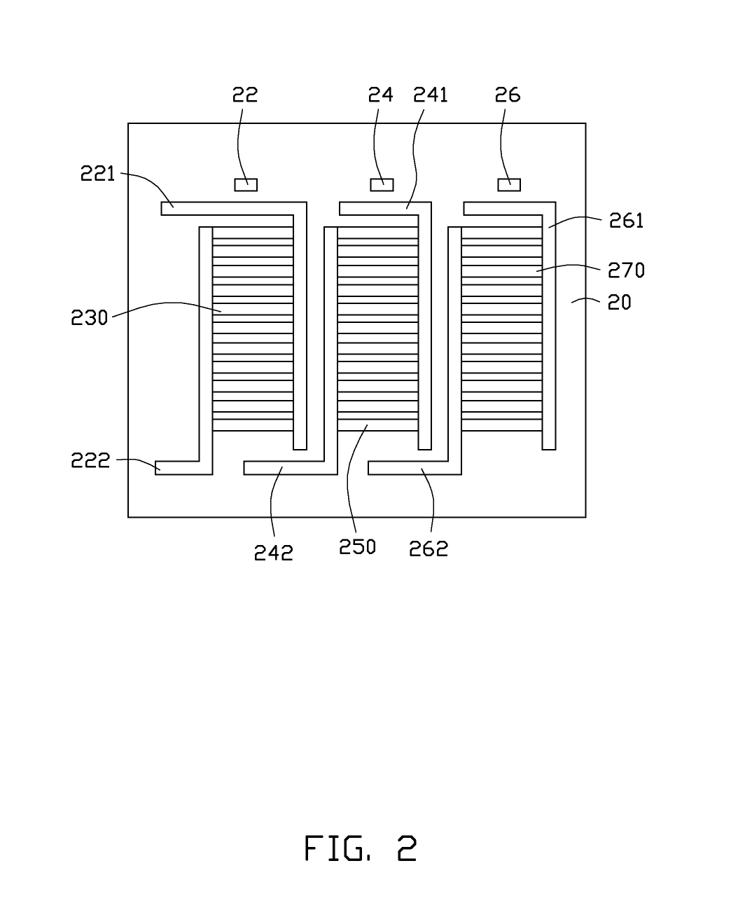

FIGS. 1-2 show a loudspeaker 200 according to an exemplary embodiment. The loudspeaker 200 includes a base 20 and a cover 21. The cover 21 is adhered on the base 20 by glue 28.

The cover 21 together with the base 20 defines a space and the space is divided into a high frequency space 211, a middle frequency space 212, and a low frequency space 213 by spacers 210. The low frequency space 213 has a largest height between the cover 21 and the base 20. The high frequency space 211 has a smallest height between the cover 21 and the base 20.

All of the high frequency space 211, the middle frequency space 212, and the low frequency space 213 define micro holes 214 thereon. The micro hole 214 is V-shaped and the diameter of the micro hole 214 reduces from the cover 21 towards the base 20. The micro hole 214 can prevent dust particles etc. from entering the space between the cover 21 and the base 20.

Material of the cover 21 and the base 20 are selected from the group of glass, rigid plastic, and metal. The glass can be quartz glass or boron-silicon glass.

A high frequency drive 22, a first high frequency pole 221, a second high frequency pole 222, and a first carbon nanotube film 23 are located on the base 20 in the high frequency space 211. The first carbon nanotube film 23 includes a plurality of first carbon nanotubes 230 parallel to each other. The high frequency drive 22 is connected with one end of each of the first carbon nanotubes 230 through the first high frequency pole 221 and is connected with the other end of each of the first carbon nanotubes 230 through the second high frequency pole 222. The high frequency drive 22 receives high frequency signals and transforms the high frequency signals into voltage signals. The voltage signals are applied to the first high frequency pole 221 and the second high frequency pole 222. Thus, the first carbon nanotubes 230 receive the voltage signals. A mechanical vibration of the first carbon nanotube film 23 is produced by the voltage signal. The first carbon nanotube film 23 reproduces sound waves corresponding to the voltage signals. The sound waves spread out of the high frequency space 211 passing through the micro holes 214.

A middle frequency drive 24, a first middle frequency pole 241, a second middle frequency pole 242, and a second carbon nanotube film 25 are located on the base 20 in the middle frequency space 212. The second carbon nanotube film 25 includes a plurality of second carbon nanotubes 250. The second carbon nanotubes 250 are parallel to each other and parallel to the first carbon nanotubes 230. The middle frequency drive 24 is connected with one end of each of the second carbon nanotubes 250 through the first middle frequency pole 241 and is connected with the other end of each of the second carbon nanotubes 250 by the second middle frequency pole 242. The middle frequency drive 24 receives middle frequency signals and transforms the middle frequency signals into voltage signals. The voltage signals are applied to the first middle frequency pole 241 and the second middle frequency pole 242. Thus, the second carbon nanotubes 250 receive the voltage signals. A mechanical vibration of the second carbon nanotube film 25 is produced by the voltage signal. The second carbon nanotube film 25 reproduces the sound waves corresponding to the voltage signals. The sound waves spread out of the micro holes 214 of the middle frequency space 212.

A low frequency drive 26, a first low frequency pole 261, a second low frequency pole 262, an a third carbon nanotube film 27 are set on the base 20 in the low frequency space 213. The third carbon nanotube film 27 includes a plurality of third carbon nanotubes 270. The third carbon nanotubes 270 are parallel to each other and are parallel to the first carbon nanotubes 230 and the second carbon nanotubes 250. The low frequency drive 26 is connected with one end of each of the third carbon nanotubes 270 through the first low frequency pole 261 and is connected with the other end of each of the third carbon nanotubes 270 by the second low frequency pole 262. The low frequency drive 26 receives low frequency signals and transforms the low frequency signals into voltage signals. The voltage signals are applied to the first low frequency pole 261 and the second low frequency pole 262. Thus, the third carbon nanotubes 270 receive the voltage signals. A mechanical vibration of the third carbon nanotube film 27 is produced by the voltage signal. The third carbon nanotube film 27 reproduces the sound waves corresponding to the voltage signals. The sound waves spread out of the micro holes 214 of the low frequency space 213.

Material of all of the high frequency poles 221 and 222, the middle frequency poles 241 and 242, and the low frequency poles 261 and 262 are selected from the group of conductive glue, metal wire, and conductive ink.

All of the first carbon nanotube film 23, the second carbon nanotube film 25, and the third carbon nanotube film 27 are single layer, two layers, or more than two layers. Each layer includes carbon nanotubes being parallel to each other.

The glue 28 is located between the cover 21 and the base 20, so that the first carbon nanotube film 23, the second carbon nanotube film 25, and the third carbon nanotube film 27 are sealed between the cover 21 and the base 20.

Carbon nanotubes have good performance of chemical resistance and moisture-proof ability, so the loudspeaker 200 having carbon nanotube film has the same performances.

All the first carbon nanotube film 23, the second carbon nanotube film 25, and the third carbon nanotube film 27 are protected between the cover 21 and base 20, so accidental damage cannot happen.

The high frequency space 211, the middle frequency space 212, and the low frequency space have different heights from the cover 21 to the base 20. The sound waves produced by the first carbon nanotube film 23, the second carbon nanotube film 25, and the carbon nanotube film third 27 have different distances, so the loudspeaker 200 has good sound mix.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A loudspeaker, comprising:
a base; and
a cover fixed on the base, the cover cooperating with the base to define a high frequency space, a middle frequency space, and a low frequency space, the high frequency space, the middle frequency space, and the low frequency space separating from each other, the cover defining a plurality of micro holes on the high frequency space, the middle frequency space, and the low frequency space, a height of the middle frequency space between the cover and the base being bigger than a height of the high frequency space between the cover and the base and being less than a height of the low frequency space between the cover and the base, the cover comprising:
a high frequency drive, a high frequency pole, and a first carbon nanotube film in the high frequency space, the high frequency drive connecting with the first carbon nanotube film through the high frequency pole, the first carbon nanotube film reproducing first sound waves corresponding to the high frequency drive, and the first sound waves spreading out of the micro holes of the high frequency space;
a middle frequency drive, a middle frequency pole, and a second carbon nanotube film in the middle frequency space, the middle frequency drive connecting with the second carbon nanotube film through the middle frequency pole, the second carbon nanotube film reproducing second sound waves corresponding to the middle frequency drive, and the second sound waves spreading out of the micro holes of the middle frequency space; and
a low frequency drive, a low frequency pole, and a third carbon nanotube film in the low frequency space, the low frequency drive connecting with the third carbon nanotube film through the low frequency pole, the third carbon nanotube film reproducing third sound waves corresponding to the low frequency drive, and the third sound waves spreading out of the micro holes of the low frequency space.

2. The loudspeaker of claim 1, wherein each of the micro holes is V-shaped, and a diameter of each of the micro holes reduces from the cover to the base.

3. The loudspeaker of claim 1, wherein all of the high frequency pole, the middle frequency pole, and the low frequency pole are made of material selected from the group consisting of conductive glue, metal wire, and conductive ink.

4. The loudspeaker of claim 1, wherein the cover and the base are made of material selected from the group consisting of glass, rigid plastic, and metal.

5. The loudspeaker of claim 4, wherein the glass is quartz glass or boron-silicon glass.

6. The loudspeaker of claim 1, wherein glue is located between the cover and the base.

7. The loudspeaker of claim 1, wherein all of the first carbon nanotube film, the second carbon nanotube film, and the third carbon nanotube film are single layer, two layers, or three layers consisting of parallel nanotubes.
